(19) United States
(12) Patent Application Publication
(10) Pub. No.: US 2022/0408127 A1
(43) Pub. Date: Dec. 22, 2022

(54) SYSTEMS AND METHODS FOR SELECTING EFFICIENT ENCODERS FOR STREAMING MEDIA

(71) Applicant: Meta Platforms, Inc., Menlo Park, CA (US)

(72) Inventor: Colleen Kelly Henry, Oakland, CA (US)

(21) Appl. No.: 17/349,494

(22) Filed: Jun. 16, 2021

(51) Int. Cl. H04N 21/234; H04N 21/845; H04N 21/239

(52) U.S. Cl. CPC H04N 21/23418; H04N 21/8456; H04N 21/2393

(57) ABSTRACT

A computer-implemented method for selecting efficient encoders for streaming media may include (i) predicting that an expected download demand for a higher-demand segment of a media file is higher than an expected download demand for a lower-demand segment, (ii) encoding each segment of the media file with an encoder that correlates to the expected download demand of the segment by (a) encoding the higher-demand segment with a more computationally intensive encoder that produces a more efficiently compressed segment compared to a less computationally intensive encoder that produces a less efficiently compressed segment and (b) encoding the lower-demand segment with the less computationally intensive encoder, and (iii) enabling streaming of the media file by providing the more efficiently compressed encoding of the higher-demand segment and the less efficiently compressed encoding of the lower-demand segment. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for selecting efficient encoders for streaming media.

FIG. 2 is a flow diagram of an exemplary method for selecting efficient encoders for streaming media.

FIG. 3 is an illustration of exemplary segments of streaming media.

FIG. 4 is an illustration of an exemplary system for selecting efficient encoders for streaming media.

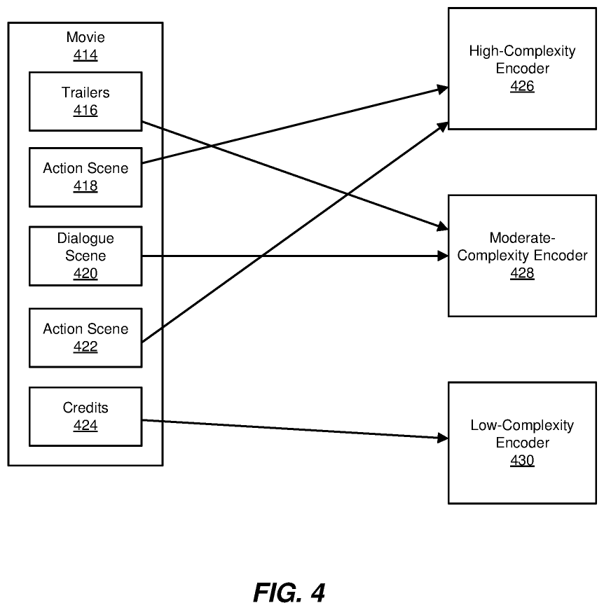

FIG. 5 is an illustration of an exemplary system for selecting efficient encoders for streaming media.

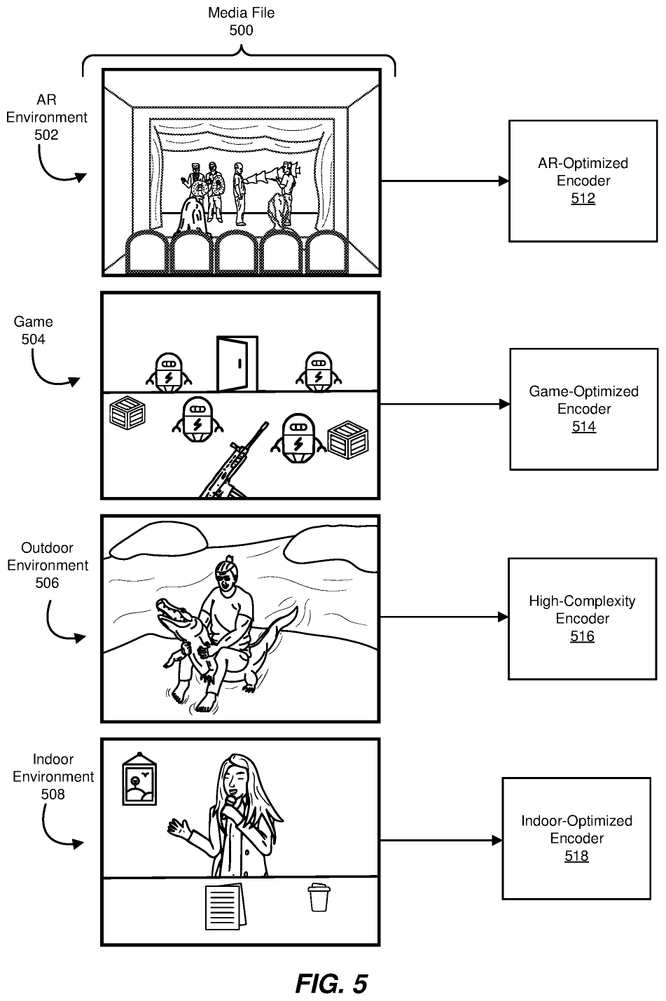

FIG. 6 is an illustration of exemplary segments of streaming media.

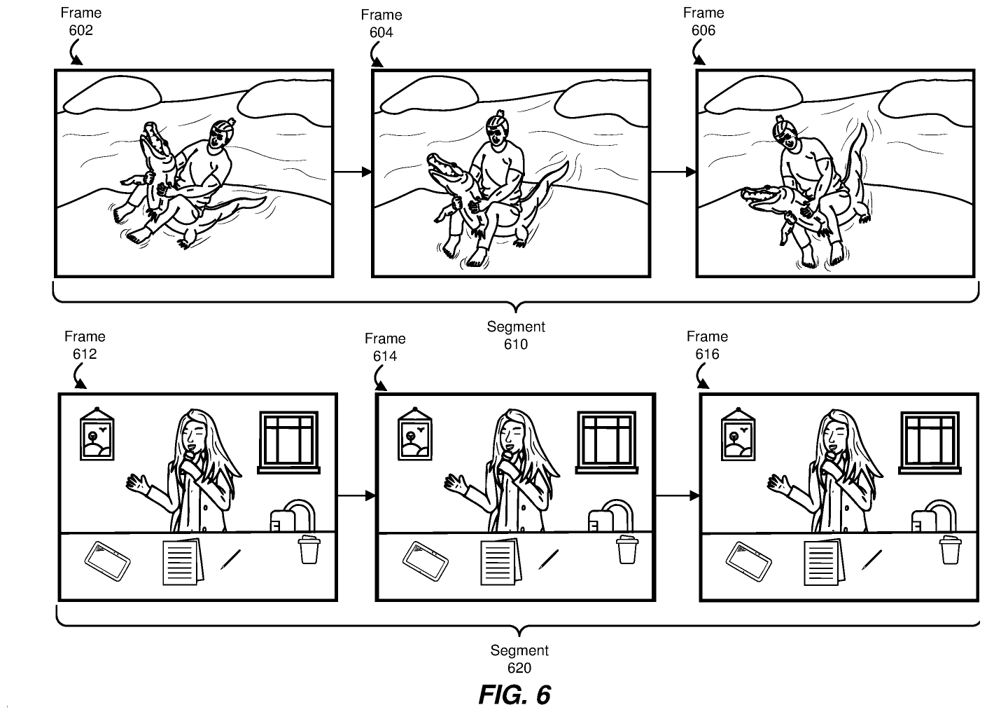

FIG. 7 is an illustration of exemplary segments of audio media.

Throughout the drawings, identical reference characters and descriptions indicate similar, but not necessarily identical, elements. While the exemplary embodiments described herein are susceptible to various modifications and alternative forms, specific embodiments have been shown byway of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for facilitating the download and/or streaming of video or other media at optimal quality while best utilizing finite computation capacity on the devices that are processing the media for delivery. Video compression and/or encoding may involve a tradeoff between the quality per bit of the resulting file or stream and computing resources (e.g., central processing unit (CPU) power, CPU time, memory, etc.). With more time or resources, a system may compress an image or video with a smaller bitrate at a given quality per bit or better quality at a given bitrate. Some encoders may only be able to encode video one way, and this tradeoff is fixed. Other encoders may have settings that enable a tradeoff between compression and computational resources. In some examples, there may be multiple different encoder implementations of a given codec. In some embodiments, hardware encoders may produce files of lower quality for a given bitrate in comparison to software encoders but may be more power and/or thermally efficient. are capable of encoding high quality video in a small file size. However, these encoders often consume considerable Similarly, many existing encoders are capable of encoding video while consuming minimal computing resources, but the output of these encoders is low in quality and/or large in file size. The systems described herein may facilitate streaming video at optimal quality by prioritizing the use of different encoder types or settings to result in an optimal result for cost or stream quality. For example, in order to achieve a higher quality-per-bit output, the systems described herein may designate portions of a video for computationally intensive software encoding when those portions are going to be in in high demand, while using less efficient and computationally intensive encoders or settings for segments of video with low or no demand. For example, if certain portions of a video are predicted to be watched more often than other portions (e.g., an exciting action scene versus the credits), the system may apply more efficient but CPU-intensive compression algorithms to the more highly watched video segments and less efficient, lower-CPU-cost compression algorithms to the segments predicted to be downloaded less often.

In some embodiments, the systems described herein may improve the functioning of a computing device by configuring the computing device to efficiently encode video or other media at high quality while conserving computing resources. For example, the systems described herein may conserve CPU power, CPU time, memory, etc., while still producing high quality encoded video files. In some embodiments, the systems described herein may conserve bandwidth by compressing portions of a media file to a smaller size than otherwise. Additionally, the systems described herein may improve the fields of streaming video, audio, metadata, depth, alpha channel, and/or other streaming media (e.g., music) by reducing file sizes or stream bitrates while maintaining quality.

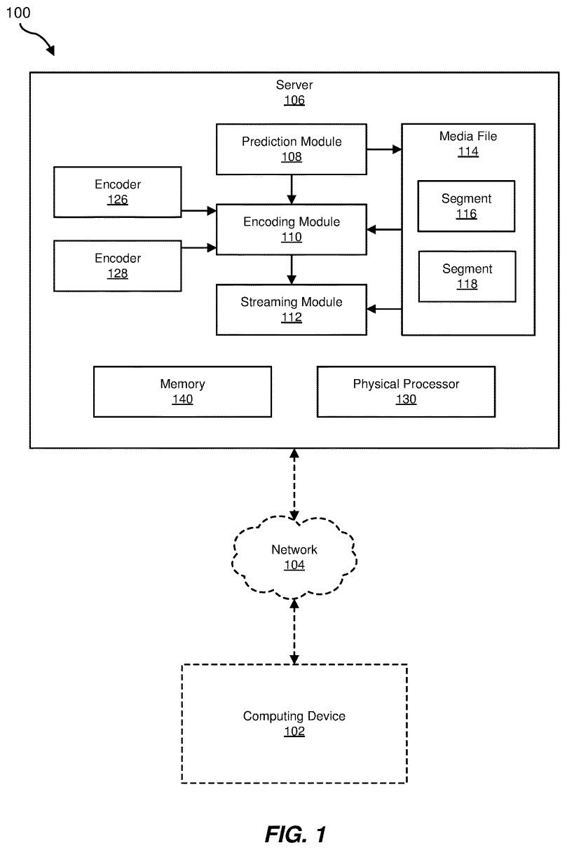

In some embodiments, the systems described herein may be implemented on a server. FIG. 1 is a block diagram of an exemplary system 100 for selecting efficient encoders for streaming media from a server to additional devices. In one embodiment, and as will be described in greater detail below, a server 106 may be configured with a prediction module 108 that may predict that an expected download demand for a segment 116 of a media file 114 is higher than an expected download demand for a segment 118 of media file 114, where each segment of media file 114 is a non-overlapping time-bounded portion of media file (such as an IDR frame) 114. Server 106 may also be configured with an encoding module 110 that may encode each segment of media file 114 with an encoder that correlates to the expected download demand of the segment by encoding segment 116 with an encoder 126 that produces a more efficiently compressed segment at a higher cost in power or resources compared to an encoder 128 that produces a less efficiently compressed segment at a lower cost in power or resources. In some examples, encoding module 110 may encode segment 118 with encoder 128. Server 106 may additionally be configured with a streaming module 112 that may enable streaming of media file 114 by providing the more efficiently compressed encoding of segment 116 and the less efficiently compressed encoding of segment 118. In some examples, server 106 may stream media file 114 to a computing device 102 via a network 104.

Server 106 generally represents any type or form of backend computing device that may process, host, and/or stream media files. Examples of server 106 may include, without limitation, media servers, application servers, database servers, and/or any other relevant type of server. Although illustrated as a single entity in FIG. 1, server 106 may include and/or represent a group of multiple servers that operate in conjunction with one another.

Media file 114 generally represents any type or form of digital media. In some embodiments, media file 114 may be a video file. Additionally or alternatively, media file 114 may be an audio file. In some examples, media file 114 may be a video file that has not yet been encoded and/or compressed. In other examples, media file 114 may be a video file that has already been encoded but which is being transcoded (e.g., encoded in a different format). In some embodiments, media file 114 may be a live streaming media file that is being recorded in real time, such that new segments of media file 114 are being recorded as previous segments of media file 114 are being encoded and/or transmitted. In other embodiments, media file 114 may be a pre-recorded media file that has been recorded in its entirety before being encoded and/or transmitted.

Encoders 126 and/or 128 generally represent any type or form of software, firmware, and/or hardware that is capable of transforming a media file into a specified format and/or compressing a media file. In some embodiments, encoders 126 and/or 128 may represent video encoders. Additionally or alternatively, encoders 126 and/or 128 may represent audio encoders. In some examples, encoder 126 and/or encoder 128 may be the encoder portion of a codec. In some embodiments, encoder 126 and/or encoder 128 may represent different encoder schemes (e.g., H.264 versus AOMedia Video 1). Additionally or alternatively, encoder 126 and/or encoder 128 may represent the same encoder scheme provided with different flags and/or parameter values that trigger the encoder to perform compression of different computational complexity.

Computing device 102 generally represents any type or form of computing device capable of reading computer-executable instructions. For example, computing device 102 may represent an endpoint device and/or personal computing device. Examples of computing device 102 may include, without limitation, a laptop, a desktop, a wearable device, a smart device, an artificial reality device, a personal digital assistant (PDA), etc.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

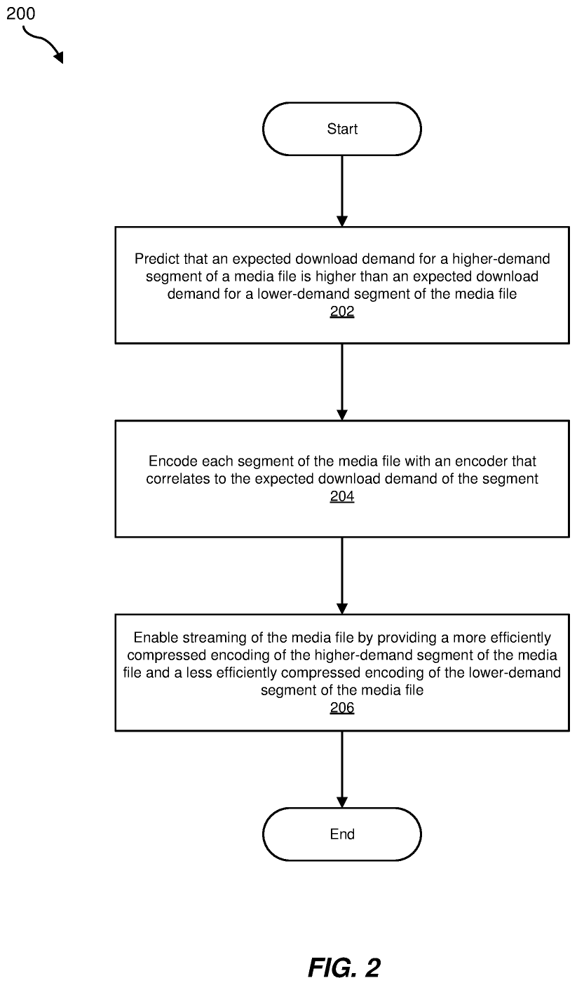

FIG. 2 is a flow diagram of an exemplary method 200 for selecting efficient encoders for streaming media. In some examples, at step 202, the systems described herein may predict that an expected download demand for a higher-demand segment of a media file is higher than an expected download demand for a lower-demand segment of the media file. For example, prediction module 108 may, as part of server 106 in FIG. 1, predict that an expected download demand for segment 116 of media file 114 is higher than an expected download demand for segment 118 of media file 114.

The term “segment” or “segment of a media file” may generally refer to any time-bounded portion of a media file. For example, a segment may be a collection of consecutive frames of a video file. In some embodiments, a segment may include a set number of frames of a video file that is consistent for each segment of a particular video file. For example, a segment may include a series of intra-frames or one intra-frame followed by inter-frames (e.g., a B-frame or P-frame), such as a group of pictures (GOP). In one example, a segment may include any number of intra-frames and/or GOPs. Additionally or alternatively, a segment may refer to a scene within a video. In some embodiments, each segment of a video file may be non-overlapping. That is, each segment may start after the end of a previous segment and/or each frame of a video file may be contained in exactly one segment. In some examples, all segments of a media file may initially be recorded and/or stored at the same quality.

Prediction module 108 may predict the expected download demand for each segment in a variety of ways and/or based on a variety of different factors. In some examples, prediction module 108 may identify a segment type of each segment and retrieve historical download data for the segment type. In some examples, prediction module 108 may identify that the segment is of a type that, historically, has high download demand. For example, prediction module 108 may identify that a segment includes or is part of an action scene in a movie, a touchdown during a football game, or another type of segment that a high proportion of viewers of similar media files typically watch and/or that some viewers typically watch multiple times, and therefore the segment is a higher-demand segment. In other examples, prediction module 108 may identify that the segment is of a type that, historically, has relatively low download demand. For example, prediction module 108 may identify that the segment includes or is part of the credits of a movie, a commercial break, or another type of segment that a low proportion of viewers of similar media file typically watch, and therefore is a lower-demand segment. In some embodiments, prediction module 108 may use machine learning to make predictions and/or improve prediction accuracy over time.

In some embodiments, prediction module 108 may classify segments based on whether expected download demand for a given segment meets a threshold for expected download demand. A threshold may be based on a set number of downloads and/or views and/or may be based on a percentage of downloads and/or views compared to total viewership of the media file. For example, prediction module 108 may classify a segment as a higher-demand segment if the segment is expected to be downloaded by at least ten thousand unique devices and/or downloaded at least ten thousand times across any number of devices. In another example, prediction module 108 may classify a segment as a higher-demand segment if the segment is expected to be downloaded by at least 95% of all devices that download any portion of the media file. In some embodiments, the systems described herein may have multiple thresholds. For example, prediction module 108 may classify a segment as lower-demand if the segment is expected to have fewer than one thousand downloads and as moderate-demand if the segment is expected to have between one thousand and ten thousand downloads.

At step 204, one or more of the systems described herein may encode each segment of the media file with an encoder that correlates to the expected download demand of the segment. For example, encoding module 110 may, as part of server 106 in FIG. 1, encode each segment of media file 114 with an encoder that correlates to the expected download demand of the segment by encoding segment 116 with encoder 126 that produces a more efficiently compressed segment compared to encoder 128 that produces a less efficiently compressed segment and encoding segment 118 with encoder 128.

Encoding module 110 may select an encoder for each segment in a variety of ways. In some embodiments, encoding module 110 may select an encoder based entirely on expected download demand. Additionally or alternatively, encoding module 110 may select an encoder based at least in part on other characteristics of a segment. For example, encoding module 110 may identify various characteristics of the segment such as how similar each frame is to the surrounding frames, how large areas of similar color are within the frame, how much contrast exists between areas within each frame, what type of motion occurs between frames, and/or any other relevant characteristic and may select an encoder that is optimized to encode a segment with those characteristics. In some embodiments, encoding module 110 may infer characteristics of a segment based on a source of the segment, such as whether the segment was recorded with a physical camera in an outdoor environment versus a virtual camera in an artificial reality (AR) environment for a specific game with known visual characteristics. In some examples, encoding module 110 may encode a predicted high-demand segment with a low-complexity encoder because the segment will not benefit from being encoded with a higher-complexity encoder (e.g., due to the segment being low complexity).

In some examples, encoding module 110 may switch between hardware and software encoders while encoding segments to the same video or audio codec. In one embodiment, encoding module 110 may switch between codecs on the fly if encoding for a client that supports such switching. In some examples, encoding module 110 may be configured to switch between encoders at scene boundaries and/or shot transitions rather than mid-shot to avoid visual indicators (e.g., pulsing) that may alert a viewer to a change in encoding.

In some examples, encoding module 110 may re-encode a segment if the systems described herein determine that the initial encoding strategy for the segment does not match the actual demand for a segment. For example, prediction module 108 may initially predict that a video segment will be in low demand and encoding module 110 may encode the video segment with a low-complexity encoder. The systems described herein may monitor demand for the segment and may determine that the segment is in high demand. In response, encoding module 110 may re-encode the segment with a high-complexity encoder that produces a more efficiently encoded segment.

At step 206, one or more of the systems described herein may enable streaming of the media file by providing the more efficiently compressed encoding of the higher-demand segment of the media file and the less efficiently compressed encoding of the lower-demand segment of the media file. For example, streaming module 112 may, as part of server 106 in FIG. 1, enable streaming of media file 114 by providing the more efficiently compressed encoding of segment 116 of media file 114 and the less efficiently compressed encoding of segment 118 of media file 114.

Streaming module 112 may provide the encoded segments in a variety of ways. For example, streaming module 112 may make the segments available for download. In some examples, streaming module 112 may transmit one or more segments. In one example, streaming module 112 may transmit all of the segments in the media file. In another example, streaming module 112 may transmit, to any given device, some higher-demand segments but not other lower-demand segments. For example, streaming module 112 may receive a request from a computing device to transmit the higher-demand segment, transmit the higher-demand segment to the computing device, fail to receive a request from the computing device to transmit the lower-demand segment, and decline to transmit the lower-demand segment to the computing device due to not receiving a request. Because streaming module 112 may transmit more higher-demand segments than lower-demand segments (due to the lower demand for the lower-demand segments) and the higher-demand segments are encoded to a smaller bit rate and/or file size, streaming module 112 may conserve bandwidth compared to transmitting segments encoded by a comparatively less-resource-intensive encoder that produces segments of a comparatively larger bit rate and/or file size.

In some embodiments, streaming module 112 may stream video and/or audio media files on a social networking platform. For example, a social networking platform may enable users to upload recorded videos and/or live stream videos and streaming module 112 may make these videos available for download and/or streaming.

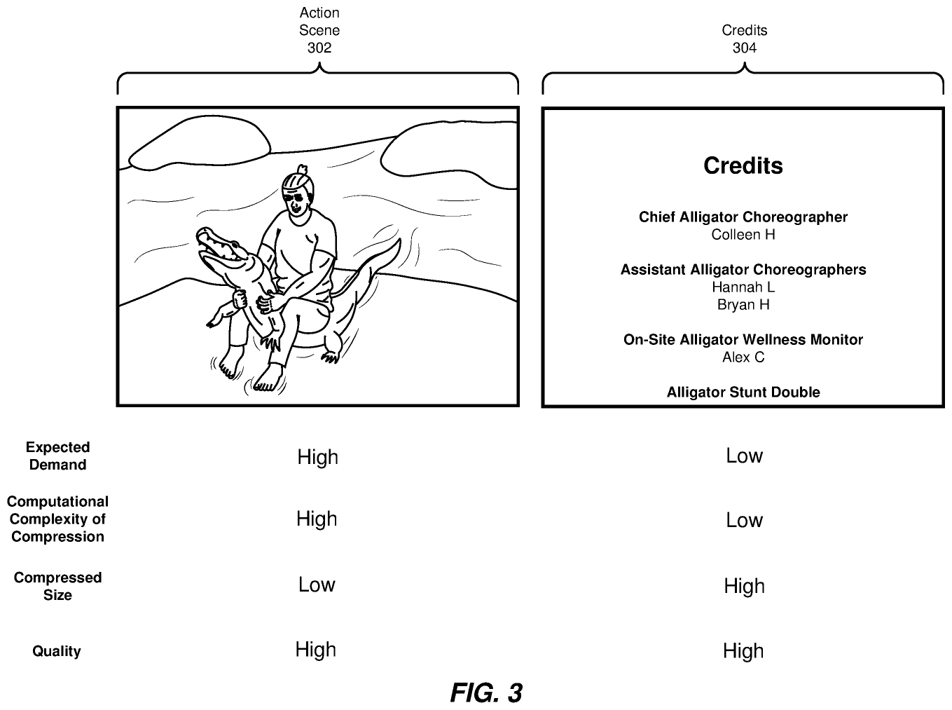

In some embodiments, the systems described herein may encode video segments at the same or a similar quality (e.g., resolution, score via an objective video quality model, etc.) despite encoding the segments using different encoders that produce output of different file sizes. For example, as illustrated in FIG. 3, the systems described herein may determine that an action scene 302 of a movie about alligator wrestling is expected to have high demand, while the credits 304 of the movie are expected to have low demand due to viewers watching the action scenes (possibly more than once) but stopping the video stream as soon as the credits begin.

In some examples, the systems described herein may select an encoder with high computational complexity (e.g., an encoder that uses a high amount of computing resources such as CPU power, CPU time, memory, etc.) to encode action scene 302 and an encoder with comparatively lower computational complexity to encode credits 304. The resulting encoded video segments may be of similarly high quality, but the encoded version of action scene 302 may have a much smaller bit rate and/or file size (e.g., compared to the unencoded version and/or compared to another encoded segment) than credits 304. For example, action scene 302 and credits 304 may each represent one minute of video in high-definition quality. In this example, it may take ten seconds to encode action scene 302 but the resulting file size may only be 5 megabytes (MB), while it may take only one second to encode credits 304 but the resulting file size may be 20 MB. Because action scene 302 is expected to be downloaded much more frequently than credits 304, it may be efficient to spend the computing resources to encode action scene 302 at a high rate of compression to conserve bandwidth while conserving computing resources by encoding credits 304 at a lower rate of compression.

In some embodiments, the systems described herein may select from a list of multiple encoders based on the expected demand for segments and/or other characteristics of segments. For example, a movie 414 may include segments representing trailers 416, action scene 418, dialogue scene 420, action scene 422, and/or credits 424. In one embodiment, the systems described herein may select among a high-complexity encoder 426, a moderate-complexity encoder 428, and/or a low-complexity encoder 430.

In one example, the systems described herein may predict expected demand and/or select an appropriate encoder based at least in part on the type of scene included in each segment. For example, the systems described herein may select high-complexity encoder 426 for action scene 418 and/or action scene 422 due to high expected demand for action scenes. Similarly, the systems described herein may select low-complexity encoder 430 to encode credits 424 due to expected low demand for credits scenes and/or moderate-complexity encoder 428 to encode dialogue scene 420 and/or trailers 416 due to an expected moderate level of demand for dialogue scenes and/or trailers.

The systems described herein may determine the type of each segment and/or scene in a variety of ways. In some embodiments, each segment and/or scene may be tagged with metadata that the systems described herein interprets to determine the type of segment and/or scene. Additionally or alternatively, the systems described herein may analyze the characteristics of segments such as the types of audio, motion, and/or color distribution within each segment to determine a probable type of the segment. In one embodiment, the systems described herein may use a machine learning classifier trained on segments of various types to classify segments. In some embodiments, the systems described herein may perform two-pass encoding by encoding one resolution or bitrate of an adaptive bitrate video and using information from that first pass of encoding to inform decisions to make on a second pass of the same rendition and/or to inform other renditions.

In some embodiments, the systems described herein may obtain information about a source for a segment, such as a game engine that generated a segment or an environment in which a segment was recorded, and may select an encoder that is optimized to encode segments from that source. For example, a particular encoder may use compression strategies that are optimal for encoding segments with a particular range of color, rate of motion, and/or other characteristics of segments generated by a specific source, and the systems described herein may select that encoder to encode segments generated by the source while selecting a different encoder to select segments not generated by the source. In some examples, a media file may include segments generated by multiple sources, such as segments generated by a game engine and segments captured by a physical camera of a streamer playing a game, or segments of a sporting event captured in an outdoor environment alternating with segments of commentators captured in an indoor environment. For example, a media file 500 may include segments originating from an AR environment 502, a game 504, an outdoor environment 506, and/or an indoor environment 508.

In one example, the systems described herein may encode segments originating from AR environment 502 with an AR-optimized encoder 512 that is designed and/or configured to efficiently encode the type of visual and/or audio data typically generated by AR environment 502. Similarly, the systems described herein may encode segments originating in game 504 with a game-optimized encoder 514. In one embodiment, the systems described herein may read metadata generated by an AR system, game platform, and/or game to determine the specific source of segments captured by a virtual camera. For example, game 504 may generate metadata that the systems described herein read to determine that segments originate from game 504. In some embodiments, the systems described herein may be configured with a library of game information and may retrieve game information from this library to determine an efficient encoder for data generated by specific games and/or categories of games. For example, if game 504 is a first-person shooter game, the systems described herein may select an encoder that is optimized for segments with a high degree of change between frames, while if game 504 is a collectible card game, the systems described herein may select an encoder that is optimized for segments with a low degree of change between frames.

In some cases, the systems described herein may be configured with specific encoders for some sources but not others. For example, one encoder may be comparatively better at encoding content with film grain while another encoder may be better at encoding content with animated or synthetically generated content with smooth gradients. In one example, a video asset may contain scenes with both film grain and with animated content at different subsets within the video. In another example, one encoder may be more suited to high motion versus a slide presentation or video conferencing or to a static camera versus an action camera. In one example, the systems described herein may not have an encoder specific to segments captured by a physical camera an outdoor environment and may therefore encode segments originating from outdoor environment 506 entirely according to expected demand. For example, the systems described herein may encode a segment originating from outdoor environment 506 with a high-complexity encoder 516. In one example, the systems described herein may be configured with an encoder optimized for segments captured by physical cameras in indoor environments (e.g., where there is likely to be less depth of field, less change between frames, etc.) and may encode segments originating from indoor environment 508 with an indoor-optimized encoder 518.

As mentioned above, in some embodiments, the systems described herein may select an encoder based at least in part on characteristics of a segment, such as the rate of change between frames in a segment (e.g., caused by camera movements, cuts, the motion of objects within the frame, etc.), the range of colors present within a segment, and/or other relevant characteristics that can affect what compression strategy is optimal for a given segment. For example, a segment 610 may include frames 602, 604, and/or 606. In this example, there may be a number of changes between each frame; the river flowing by in the background may move, the alligator may buck, and/or the man wrestling the alligator may move as a result of the alligator's motion. There may only be a small degree of similarity between the values of the pixels in frame 604 compared to the values of the pixels in the surrounding frames 602 and 606. By contrast, frames 612, 614, and/or 616 of a segment 620 depicting a commentator on the alligator wrestling may be identical or nearly identical. A video encoder that is optimized to take advantage of inter-frame prediction may be able to compress segment 620 to a small size at a high degree of quality but may not be able to do the same for segment 610. However, segment 620 may feature large uninterrupted areas with the same or similar colors of pixels (e.g., muddy ground, greenish river, grey boulders, etc.) while segment 610 may be broken up into smaller areas of color, meaning that an encoder optimized for intra-frame prediction may encode segment 610 more efficiently than segment 620. In some examples, the systems described herein may select encoders with different compression strategies for segment 610 and segment 620 in order to efficiently encode each segment, rather than using the same encoder for both segments due to both segments being part of the same video stream and of the same quality.

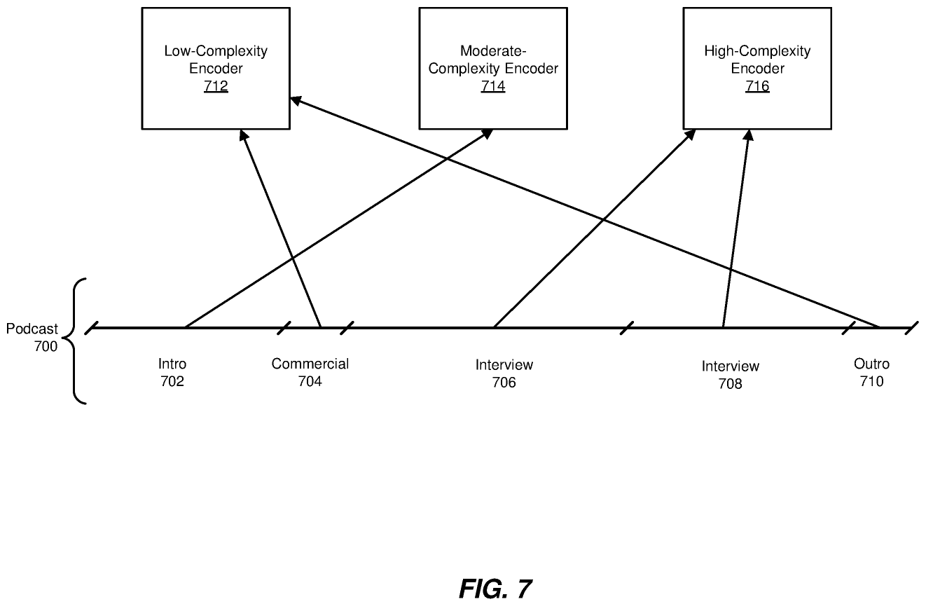

In some embodiments, the systems described herein may apply any or all of the above-described strategies to encode other types of media files, such as audio files. For example, as illustrated in FIG. 7, a podcast 700 may be composed of an intro 702, a commercial 704, an interview 706, an interview 708, and/or an outro 710. In some embodiments, the systems described herein may predict that a large proportion of listeners will skip past intro 702, even more listeners will skip past commercial 704, all or nearly all listeners will listen to interview 706 and/or 708, and most listeners will turn off the audio stream at the start of outro 710. In response to these predictions of expected demand, the systems described herein may encode segments from commercial 704 and/or outro 710 with a low-complexity encoder 712, segments from intro 702 with a moderate-complexity encoder 714, and/or segments from interviews 706 and/or 708 with a high-complexity encoder 716.

As described above, the systems and methods described herein may conserve computing resources while producing high-quality media for streaming and/or download by selecting different encoders for different segments of the same media file based on expected demand and/or other characteristics, rather than encoding an entire media file with the same encoder. A given computing device or cluster of computing devices tasked with encoding a media file may only have so many computing resources to devote to the task. In some cases, the computing device may not have sufficient computing resources to encode the entire media file at a high level of quality and an efficient bit rate. Rather than encoding the entire media file at a lower level of quality and/or less efficient bit rate, the systems described herein may encode higher-demand portions of the media file with a higher degree of compression for more efficient transmission but may encode lower-demand portions of the media file with a lower degree of compression to conserve computing resources during encoding. Because the lower-demand portions of the media file will be transmitted less frequently, the larger file size of these portions will have a minimal effect on bandwidth consumption compared to encoding the entire media file at a less efficient bit rate. Thus, the systems described herein may conserve computing resources devoted to encoding without significantly impacting bandwidth consumption.

### EXAMPLE EMBODIMENTS

Example 1: A method for selecting efficient encoders for streaming media may include (i) predicting that an expected download demand for a higher-demand segment of a media file is higher than an expected download demand for a lower-demand segment of the media file, where each segment of the media file includes a non-overlapping time-bounded portion of the media file, (ii) encoding each segment of the media file with an encoder that correlates to the expected download demand of the segment by (a) encoding the higher-demand segment with a more computationally intensive encoder that produces a more efficiently compressed segment compared to a less computationally intensive encoder that produces a less efficiently compressed segment and (b) encoding the lower-demand segment with the less computationally intensive encoder, and (iii) enabling streaming of the media file by providing the more efficiently compressed encoding of the higher-demand segment of the media file and the less efficiently compressed encoding of the lower-demand segment of the media file.

Example 2: The computer-implemented method of example 1, where the more efficiently compressed encoding of the higher-demand segment of the media file and the less efficiently compressed encoding of the lower-demand segment of the media file are both encoded at a same level of quality.

Example 3: The computer-implemented method of examples 1-2, where the more efficiently compressed encoding of the higher-demand segment of the media file and the less efficiently compressed encoding of the lower-demand segment of the media file are both encoded at a same resolution.

Example 4: The computer-implemented method of examples 1-3, where predicting that the expected download demand for the higher-demand segment of a media file is higher than the expected download demand for the lower-demand segment of the media file includes predicting that the expected download demand for the higher-demand segment meets a predetermined threshold for high download demand and predicting that the expected download demand for the lower-demand segment does not meet the predetermined threshold for high download demand.

Example 5: The computer-implemented method of examples 1-4, where predicting the expected download demand for the higher-demand segment of a media file includes identifying a segment type of the higher-demand segment and retrieving historical download data for the segment type that indicates that the segment type experiences high download demand.

Example 6: The computer-implemented method of examples 1-5, where encoding each segment of the media file with the encoder that correlates to the expected download demand of the segment includes determining a segment type of the segment and selecting an encoder that is optimized to encode the segment type.

Example 7: The computer-implemented method of examples 1-6, where determining a segment type of the segment includes determining at least one of an amount of change between each video frame of the segment, a distribution of colors of pixel within each video frame of the segment, or a type of change between each video frame within the segment.

Example 8: The computer-implemented method of examples 1-7, where encoding each segment of the media file with the encoder that correlates to the expected download demand of the segment includes detecting a source of the segment of the media file, and selecting the encoder based at least in part on the source of the segment.

Example 9: The computer-implemented method of examples 1-8, where the source of the segment of the media file includes at least one of a virtual camera within an artificial reality environment, a virtual camera within a game, a physical camera in an indoor environment, or a physical camera in an outdoor environment.

Example 10: The computer-implemented method of examples 1-9 may further include (i) receiving a request from a device to download the higher-demand segment, (ii) streaming the higher-demand segment to the device in response to the request to download the higher-demand segment, (iii) failing to receive a request from the device to download the lower-demand segment, and (iv) declining to stream the lower-demand segment to the device in response to failing to receive the request to download the lower-demand segment.

Example 11: The computer-implemented method of examples 1-10 may further include predicting that an expected download demand for a moderate-demand segment of the media file is higher than the expected download demand for the lower-demand segment of the media file and lower than the expected download demand for the higher-demand segment of the media file, and encoding the moderate-demand segment with a moderate computationally intensive encoder that produces a more efficiently compressed segment compared to the less computationally intensive encoder and a less efficiently compressed segment compared to the more computationally intensive coder.

Example 12: The computer-implemented method of examples 1-11, where each segment includes a scene of a video.

Example 13: A system for selecting efficient encoders for streaming media may include at least one physical processor and physical memory including computer-executable instructions that, when executed by the physical processor, cause the physical processor to (i) predict that an expected download demand for a higher-demand segment of a media file is higher than an expected download demand for a lower-demand segment of the media file, where each segment of the media file includes a non-overlapping time-bounded portion of the media file, (ii) encode each segment of the media file with an encoder that correlates to the expected download demand of the segment by (a) encoding the higher-demand segment with a more computationally intensive encoder that produces a more efficiently compressed segment compared to a less computationally intensive encoder that produces a less efficiently compressed segment and (b) encoding the lower-demand segment with the less computationally intensive encoder, and (iii) enable streaming of the media file by providing the more efficiently compressed encoding of the higher-demand segment of the media file and the less efficiently compressed encoding of the lower-demand segment of the media file.

Example 14: The system of example 13, where the more efficiently compressed encoding of the higher-demand segment of the media file and the less efficiently compressed encoding of the lower-demand segment of the media file are both encoded at a same level of quality.

Example 15: The system of examples 13-14, where the more efficiently compressed encoding of the higher-demand segment of the media file and the less efficiently compressed encoding of the lower-demand segment of the media file are both encoded at a same resolution.

Example 16: The system of examples 13-15, where predicting that the expected download demand for the higher-demand segment of a media file is higher than the expected download demand for the lower-demand segment of the media file includes predicting that the expected download demand for the higher-demand segment meets a predetermined threshold for high download demand and predicting that the expected download demand for the lower-demand segment does not meet the predetermined threshold for high download demand.

Example 17: The system of examples 13-16, where predicting the expected download demand for the higher-demand segment of a media file includes identifying a segment type of the higher-demand segment and retrieving historical download data for the segment type that indicates that the segment type experiences high download demand.

Example 18: The system of examples 13-17, where encoding each segment of the media file with the encoder that correlates to the expected download demand of the segment includes determining a segment type of the segment and selecting an encoder that is optimized to encode the segment type.

Example 19: The system of examples 13-18, where determining a segment type of the segment includes determining at least one of an amount of change between each video frame of the segment, a distribution of colors of pixel within each video frame of the segment, or a type of change between each video frame within the segment.

Example 20: A non-transitory computer-readable medium may include one or more computer-readable instructions that, when executed by at least one processor of a computing device, cause the computing device to (i) predict that an expected download demand for a higher-demand segment of a media file is higher than an expected download demand for a lower-demand segment of the media file, where each segment of the media file is a non-overlapping time-bounded portion of the media file, (ii) encode each segment of the media file with an encoder that correlates to the expected download demand of the segment by (a) encoding the higher-demand segment with a more computationally intensive encoder that produces a more efficiently compressed segment compared to a less computationally intensive encoder that produces a less efficiently compressed segment and (b) encoding the lower-demand segment with the less computationally intensive encoder, and (iii) enable streaming of the media file by providing the more efficiently compressed encoding of the higher-demand segment of the media file and the less efficiently compressed encoding of the lower-demand segment of the media file.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
predicting that an expected download demand for a higher-demand segment of a media file is higher than an expected download demand for a lower-demand segment of the media file, wherein each segment of the media file comprises a non-overlapping time-bounded portion of the media file;
encoding each segment of the media file with an encoder that correlates to the expected download demand of the segment by:
encoding the higher-demand segment with a more computationally intensive encoder that produces a more efficiently compressed segment compared to a less computationally intensive encoder that produces a less efficiently compressed segment; and
encoding the lower-demand segment with the less computationally intensive encoder; and
enabling streaming of the media file by providing the more efficiently compressed encoding of the higher-demand segment of the media file and the less efficiently compressed encoding of the lower-demand segment of the media file.

2. The computer-implemented method of claim 1, wherein the more efficiently compressed encoding of the higher-demand segment of the media file and the less efficiently compressed encoding of the lower-demand segment of the media file are both encoded at a same level of quality.

3. The computer-implemented method of claim 1, wherein the more efficiently compressed encoding of the higher-demand segment of the media file and the less efficiently compressed encoding of the lower-demand segment of the media file are both encoded at a same resolution.

4. The computer-implemented method of claim 1, wherein predicting that the expected download demand for the higher-demand segment of a media file is higher than the expected download demand for the lower-demand segment of the media file comprises:
predicting that the expected download demand for the higher-demand segment meets a predetermined threshold for high download demand; and
predicting that the expected download demand for the lower-demand segment does not meet the predetermined threshold for high download demand.

5. The computer-implemented method of claim 1, wherein predicting the expected download demand for the higher-demand segment of a media file comprises:
identifying a segment type of the higher-demand segment; and
retrieving historical download data for the segment type that indicates that the segment type experiences high download demand.

6. The computer-implemented method of claim 1, wherein encoding each segment of the media file with the encoder that correlates to the expected download demand of the segment comprises:
determining a segment type of the segment; and
selecting an encoder that is optimized to encode the segment type.

7. The computer-implemented method of claim 6, wherein determining a segment type of the segment comprises determining at least one of:
an amount of change between each video frame of the segment;
a distribution of colors of pixel within each video frame of the segment; or
a type of change between each video frame within the segment.

8. The computer-implemented method of claim 1, wherein encoding each segment of the media file with the encoder that correlates to the expected download demand of the segment comprises:
detecting a source of the segment of the media file; and
selecting the encoder based at least in part on the source of the segment.

9. The computer-implemented method of claim 8, wherein the source of the segment of the media file comprises at least one of:
a virtual camera within an artificial reality environment;
a virtual camera within a game;
a physical camera in an indoor environment; or
a physical camera in an outdoor environment.

10. The computer-implemented method of claim 1, further comprising:
receiving a request from a device to download the higher-demand segment;
streaming the higher-demand segment to the device in response to the request to download the higher-demand segment;
failing to receive a request from the device to download the lower-demand segment; and
declining to stream the lower-demand segment to the device in response to failing to receive the request to download the lower-demand segment.

11. The computer-implemented method of claim 1, further comprising:
predicting that an expected download demand for a moderate-demand segment of the media file is higher than the expected download demand for the lower-demand segment of the media file and lower than the expected download demand for the higher-demand segment of the media file; and
encoding the moderate-demand segment with a moderate computationally intensive encoder that produces a more efficiently compressed segment compared to the less computationally intensive encoder and a less efficiently compressed segment compared to the more computationally intensive coder.

12. The computer-implemented method of claim 1, wherein each segment comprises a scene of a video.

13. A system comprising:
at least one physical processor;
physical memory comprising computer-executable instructions that, when executed by the physical processor, cause the physical processor to:
predict that an expected download demand for a higher-demand segment of a media file is higher than an expected download demand for a lower-demand segment of the media file, wherein each segment of the media file comprises a non-overlapping time-bounded portion of the media file;
encode each segment of the media file with an encoder that correlates to the expected download demand of the segment by:
encoding the higher-demand segment with a more computationally intensive encoder that produces a more efficiently compressed segment compared to a less computationally intensive encoder that produces a less efficiently compressed segment; and
encoding the lower-demand segment with the less computationally intensive encoder; and
enable streaming of the media file by providing the more efficiently compressed encoding of the higher-demand segment of the media file and the less efficiently compressed encoding of the lower-demand segment of the media file.

14. The system of claim 13, wherein the more efficiently compressed encoding of the higher-demand segment of the media file and the less efficiently compressed encoding of the lower-demand segment of the media file are both encoded at a same level of quality.

15. The system of claim 13, wherein the more efficiently compressed encoding of the higher-demand segment of the media file and the less efficiently compressed encoding of the lower-demand segment of the media file are both encoded at a same resolution.

16. The system of claim 13, wherein predicting that the expected download demand for the higher-demand segment of a media file is higher than the expected download demand for the lower-demand segment of the media file comprises:
predicting that the expected download demand for the higher-demand segment meets a predetermined threshold for high download demand; and
predicting that the expected download demand for the lower-demand segment does not meet the predetermined threshold for high download demand.

17. The system of claim 13, wherein predicting the expected download demand for the higher-demand segment of a media file comprises:
identifying a segment type of the higher-demand segment; and
retrieving historical download data for the segment type that indicates that the segment type experiences high download demand.

18. The system of claim 13, wherein encoding each segment of the media file with the encoder that correlates to the expected download demand of the segment comprises:
determining a segment type of the segment; and
selecting an encoder that is optimized to encode the segment type.

19. The system of claim 18, wherein determining a segment type of the segment comprises determining at least one of:
an amount of change between each video frame of the segment;
a distribution of colors of pixel within each video frame of the segment; or
a type of change between each video frame within the segment.

20. A non-transitory computer-readable medium comprising one or more computer-readable instructions that, when executed by at least one processor of a computing device, cause the computing device to:
predict that an expected download demand for a higher-demand segment of a media file is higher than an expected download demand for a lower-demand segment of the media file, wherein each segment of the media file comprises a non-overlapping time-bounded portion of the media file;
encode each segment of the media file with an encoder that correlates to the expected download demand of the segment by:
encoding the higher-demand segment with a more computationally intensive encoder that produces a more efficiently compressed segment compared to a less computationally intensive encoder that produces a less efficiently compressed segment; and
encoding the lower-demand segment with the less computationally intensive encoder; and
enable streaming of the media file by providing the more efficiently compressed encoding of the higher-demand segment of the media file and the less efficiently compressed encoding of the lower-demand segment of the media file.
